(19) United States
(12) Patent Application Publication
(10) Pub. No.: US 2026/0099241 A1
(43) Pub. Date: Apr. 9, 2026

(54) METHOD AND SYSTEM FOR MANIPULATING WEATHER FORECASTS

(71) Applicant: AG2, Manchester, NH (US)

(72) Inventors: Todd Crawford, Hudson, NH (US); Devin Boyer, Washington, DC (US); Robert Boucher, Candia, NH (US)

(21) Appl. No.: 18/910,805

(22) Filed: Oct. 9, 2024

(51) Int. Cl. G06F 3/0484; G01W 1/00; G06N 20/00

(52) U.S. Cl. CPC G06F 3/0484; G01W 1/00; G06N 20/00

(57) ABSTRACT

Examples are directed to systems and methods that cause a user interface to be displayed that allows an end-user to combine, via assigning weights and bias corrections, sources that provide weather-related datapoints and emphasize the final combination of weather-related datapoints. The user interface has inputs at each datapoint of the weather-related datapoints and can receive user inputs at the inputs. The user inputs correspond to weights and bias corrections relating to the sources, and the manual or automatic combination of weighted, bias-corrected weather-related datapoints generates a customized weather forecast for a location or region

### BACKGROUND

Weather forecasts can be invaluable in making decisions, such as deciding whether or not a user should plan on going to a particular destination, deciding a route to take to a particular destination, the quantity of an item that should be purchased, or the quantity of an item that should be sold. To further illustrate, if an end-user is a energy futures trader and is trying to decide if they should purchase energy futures contracts or sell energy futures contacts, weather forecasts can be used to assist with the determination. If a weather forecast indicates that an extreme weather event is going to occur at a location that would disrupt either the demand or supply of energy, this can cause energy futures prices to change. Thus, the energy futures trader may purchase energy futures contracts in anticipation of fuel prices increasing.

However, the end-user may receive numerous weather forecasts without any indication as to which weather forecast is reliable or should be given more weight. In particular, one weather forecast may indicate that a weather event is not going to occur at an oil refinery location while another weather forecast may indicate that a weather event will occur at the oil refinery location. Therefore, the end-user is left to guess which weather forecast to rely on, which could lead to an erroneous decision being made, such as selling fuel futures contracts as opposed to purchasing fuel futures contracts.

### BRIEF DESCRIPTION OF FIGURES

FIG. 1 shows an environment in which examples may operate, in accordance with some examples.

FIG. 2 is a method for using a trained machine learning model to generate an estimated weather forecast, in accordance with some examples.

FIG. 3 is a user interface that can receive inputs that weights weather forecast sources and selects weather-related datapoints, in accordance with some examples.

FIG. 4 illustrates an estimated weather forecast generated by the trained machine learning model of FIG. 2, in accordance with some examples.

FIG. 5 shows a method for training a machine learning model, in accordance with some examples.

FIG. 6 is a user interface that can be presented to an end-user that allows the end-user to bias correct weather-related datapoints, in accordance with some examples.

FIG. 7 is a user interface that can be presented to an end-user that includes an interactive map, which can allow the end-user to request a weather forecast for a location on the interactive map, in accordance with some examples.

FIG. 8 is a block diagram illustrating an example of a machine upon which one or more examples may be implemented.

FIG. 9 illustrates a device that can be used to implement exemplary examples of the present disclosure.

### DETAILED DESCRIPTION

Examples relate to a system and method that can output a first user interface that displays weather-related datapoints along with sources that provide weather-related datapoints. The user interface can also allow an end-user to skill weight each source and emphasize certain weather-related datapoints. The system can generate an output based on the skill weights received at the user interface. Thus, an end-user can independently determine which skill weights to emphasize, which can be used to generate a weather forecast. The weather-related datapoints can be various weather-related metrics, such as temperature, wind speed, humidity, and the like. The system can generate a weather forecast based on the skill weights associated with each source. The output can be in the form of any generated computing device output. Examples can include a digital tool that can organize, analyze, and manipulate data in a tabular format. Examples can also include a data archive, a graphical output, a digital slideshow, or the like.

The system can receive various weather-related datapoints from a plurality of sources and can skill weight these datapoints to produce an optimal output, using the skill weights received from the end-user along with bias corrections from each of the sources. The skill-weighted, bias-corrected output can be combined to output values that correspond to a weather forecast output on a second user interface. In examples, an end-user can independently determine how to bias correct individual sources. Similar to the skill weighting, an end-user can independently determine how to bias correct sources, which, in combination with the independent weights provided by the end-user, can be used to generate a weather forecast. In particular, the skill weights and the bias corrections provided by an end-user can be used in conjunction with a machine learning model to output a weather forecast.

The sources can correspond to, or employ, weather models that output weather parameters at a plurality of locations. The system can compare predictive weather modeling for a location from the source with the actual weather at the location. The system can also access data listing historical weather forecasts that each of the sources predicted in the past for various locations along with the actual weather forecast for each of the locations for which the sources predicted a weather forecast in the past. Using the predicted weather forecasts along with the actual weather forecasts and historical weather forecasts, the system can determine a bias for each of the sources to be used for bias correcting.

For example, if a first source predicts a temperature of 55° F. at a first location at a time T₁ and the actual temperature is 52° F. at the time T₁, since the predicted temperature is 55° F. and the actual temperature is 52° F., the system can determine that temperature predictions from the first source run hot by an average temperature of 3° F. by determining a difference between the predicted temperature and the actual temperature. Here, the system can bias correct temperatures from the first source by reducing a temperature predicted by the first source by 3° F.

Moreover, if a second source predicts a temperature of 49° F. at the first location at the time T₁ instead of 52° F., since the predicted temperature is 49° F. and the actual temperature is 52° F., the system can determine that temperature predictions from the second source run cold by an average temperature of 3° F. by determining a difference between the predicted temperature and the actual temperature. In this instance, the system can bias correct temperatures from the second source by increasing a predicted temperature by 3° F. In additional examples, an end-user can decide that the first and second sources should be bias corrected by reducing the temperature of the first source by 4° F. and increasing the temperature of the second source by 5° F. thereby overriding bias corrections automatically made by the system.

The estimated and actual weather forecasts can be generated using spatial array paradigms. In a first spatial array paradigm, various physical locations can have weather reporting sources stationed at each of the physical locations. These weather reporting sources can provide actual weather forecasts to the system described herein as actual weather forecasts. The system described herein can also estimate weather forecasts based on the locations of the weather reporting sources. In a second spatial array paradigm, a grid array can be used where each of the weather reporting sources can be located at a first location within a grid and weather forecasts for other locations within the grid can be interpolated based on the weather forecast at the weather reporting source within the grid and weather reporting sources in adjacent grids. The system described herein can also estimate weather forecasts based on the grid array and the weather reporting sources within the grid array.

The system can employ machine learning models to generate weather forecasts. The machine learning model can include a knowledge base having weather data sets that can be accessed to predict weather forecasts based on received current weather data. Training data can be provided to the machine learning model to train the machine learning model how to correspond current weather data with future weather forecasts. The machine learning model can include any type of deep learning algorithm that can make these predictions. Examples can include Chat Generative Pre-trained Transformer (ChatGPT), Pathways Language Model (PaLM), Large Language Model Meta AI (LLaMA), BigScience Large Open-science Open-access Multilingual Language Model (BLOOM), or the like. Further examples of machine learning models that can be used can include Classification and Regression Training, gradient boosted machines, glmnet, randomForest, SciPy, XGBoost, and various neural networks, such as a Feed-Forward neural network, a radial basis function neural network, a multilayer perceptron neural network, a convolutional neural network, a recurrent neural network, and a modular neural network.

The machine learning model can use deep learning to output text through transformer neural networks. The machine learning model can be provided ground rules and then be provided data, such as actual weather forecasts. In an unsupervised format, the machine learning model can train to develop an understanding of the relationships objects in the item data having a key: value format and nodes in the hierarchical nodal structure. The machine learning model can include a Large Language Model (LLM) and more specifically an attention model. The training data can be tagged based on weather data that has a higher correspondence to an actual weather forecast.

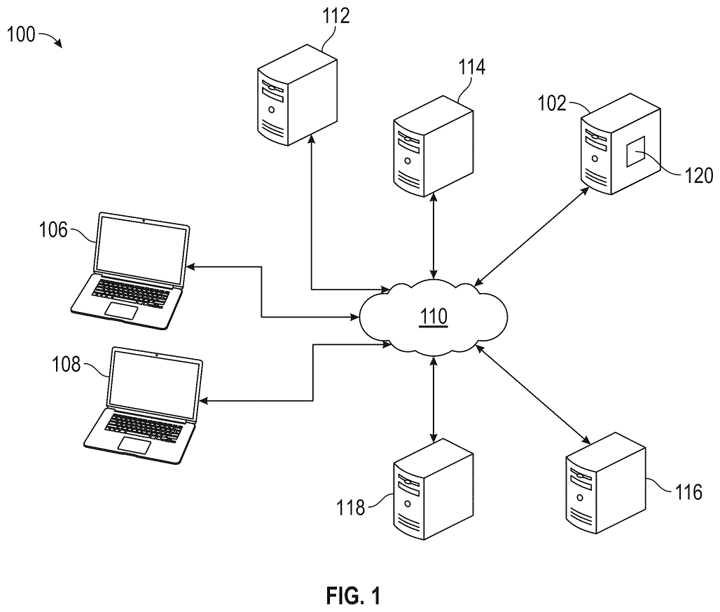

Now making reference to FIG. 1, a network environment 100 is shown in which examples can operate. The network environment 100 can include a server device 102 that can be a computing device having hardware and software functionality to perform the features discussed herein. The network environment 100 can also include devices 104-108 that can be computing devices having hardware and software functionality to perform the features discussed herein. The network environment 100 can also include a network 110 that can facilitate communication between the server device 102, the devices 104-108, and source devices 112-118. The source devices 112-118 can be associated with sources that can provide estimated weather forecasts. The source devices 112-118 can be computing devices having hardware and software functionality to perform the features discussed herein.

The network 110 can be any network that enables communication between or among machines, databases, and devices (e.g., the server device 102, the devices 104-108, and the source devices 112-118). The network 110 can be a wired network, a wireless network (e.g., a mobile or cellular network), or any suitable combination thereof. The network 110 can include one or more portions that constitute a private network, a public network (e.g., the Internet), or any suitable combination thereof. Accordingly, the network 110 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 110 can communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

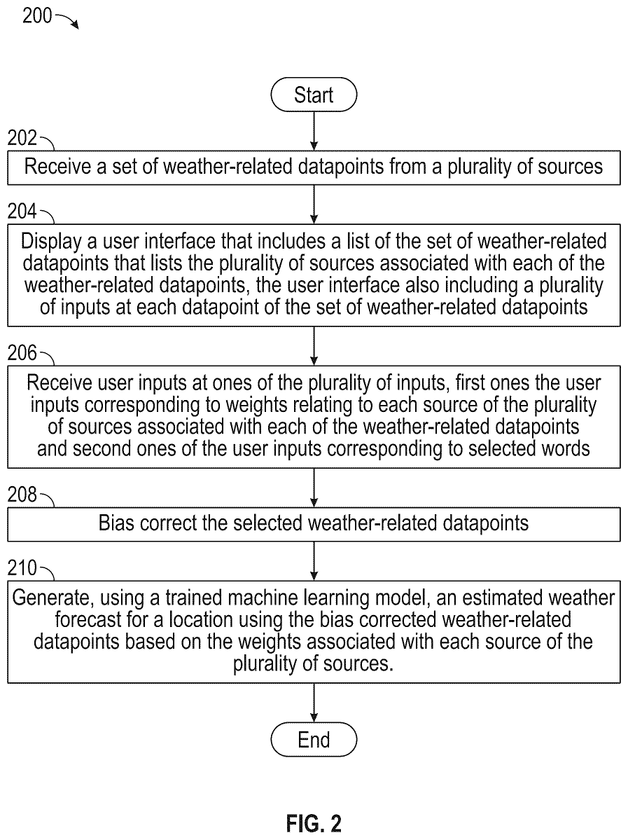

As noted above, examples relate to, among other features, a method that can output a user interface that displays weather-related datapoints along with sources that can provide each of the weather-related datapoints in order to allow an end-user to weight each source and select weather-related datapoints. Now making reference to FIG. 2, a method 200 that provides this functionality is shown. During an operation 202, a set of weather-related datapoints can be received from a plurality of sources.

The weather-related datapoints can relate to a weather forecast for a location. The weather-related datapoints can also include various scalars associated with weather for a location. The weather-related datapoints can include a temperature for the location, humidity levels for the location, and/or wind speeds for the location. The weather-related datapoints can also relate to a precipitation level for the location and a weather threat level for the location. The weather threat level can relate to a possibility or a probability of a weather-related event occurring at the location. Examples of weather-related events can include a hurricane, cyclone, thunderstorms, tornados, hail, lightening, floods, severe weather winter, wildfires, fog, ice, or any other type of weather phenomena.

After the weather-related datapoints are received, the method 200 can perform an operation 204, where a user interface that includes a list of the set of the weather-related datapoints can be displayed. The user interface can also list the plurality of sources associated with each of the weather-related datapoints. The user interface can also be caused to display a plurality of inputs at each datapoint of the set of weather-related datapoints. Each input of the plurality of inputs can be associated with each of the weather-related datapoints and can be configured to receive an input from an end-user. Examples of each input of the plurality of inputs that can be associated with each of the weather-related datapoints can include visual elements, such as buttons, checkboxes, radio buttons, and dropdown menus. Further examples can include text fields, sliders, toggle switches, or any other type of element that an end-user can use to provide an input at a weather-related datapoint. Examples of inputs that can be received from an end-user at the plurality of inputs can be numerical values, such as if the end-user is providing a weight. Further examples can include checkmarks, a star, a line, a circle, or any other any type of indicium indicating a preference for a weather-related datapoint associated with the input.

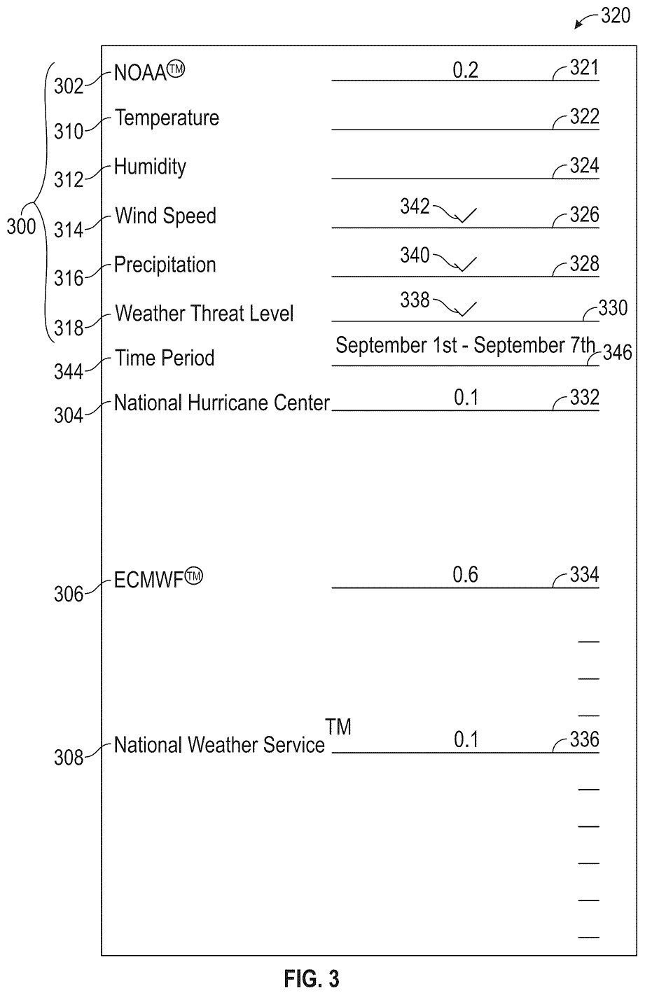

As an example of the method 200 and referred to herein as “the illustration,” a trained machine learning model 120 (hereinafter “machine learning model 120”) in conjunction with the server device 102 functions to perform the method 200. Making reference to FIGS. 1 and 3, during the operation 202, the machine learning model 120 receives weather-related datapoints 300 from the server devices 112-118. In the illustration, the server device 112 is associated with the National Oceanic and Atmospheric Administration™ (NOAA™), the server device 114 is associated with the National Hurricane Center, the server device 116 is associated with the European Centre for Medium-Range Weather Forecasts™ (ECMWF™), and the server device 118 is associated with the National Weather Service™. Each of NOAA™, the National Hurricane Center, ECMWF™, and the National Weather Service™ can be sources in the illustration.

The weather-related datapoints 300 can include sources 302-308 along with the weather-related datapoints 310-318. The source 302 can correspond to NOAA™ at the source device 112 while the source 304 can correspond to the National Hurricane Center at the source device 114. The source 306 can correspond to the ECMWF™ at the source device 116 and the source 308 can correspond to the National Weather Service™ at the source device 118.

In the illustration, the weather-related datapoint 310 can be a temperature weather-related datapoint (also referred to herein as temperature weather-related datapoint 310) and the weather-related datapoint 312 can be a humidity level weather-related datapoint (also referred to herein as humidity level weather-related datapoint 312). The weather-related datapoint 314 can be a wind speed weather-related datapoint 314 (also referred to herein as wind speed weather-related datapoint 314), the weather-related datapoint 316 can be a precipitation weather-related datapoint (also referred to herein as wind speed weather-related datapoint 316), and the weather-related datapoint 318 can be a weather threat level weather-related datapoint (also referred to herein as weather threat level weather-related datapoint 318). During the operation 202, the server device 102 can pull temperature, humidity level, wind speed, precipitation, and weather threat level weather-related datapoints from each of the sources 302-308.

Still sticking with the illustration, a user interface 320 can include the weather-related datapoints 300. The user interface 320 can include a plurality of inputs 321-336 which, in the illustration, are text fields. The inputs 321-336 can be configured to receive an input from a weather forecaster in the illustration. Moreover, during the operation 204, the server device 102 can cause the user interface 320 to be displayed on the device 108.

Returning to FIG. 2 and the method 200, during an operation 206, user inputs can be received at ones of the plurality of inputs displayed at the user interface. A first set, or first ones as shown in FIG. 2, of the user inputs can correspond to a source preference that an end-user may have for weather-related datapoints. The first set of the user inputs can correspond to skill weights relating to each source of the plurality of sources that are each associated with the weather-related datapoints. Therefore, an end-user can manually enter skill weights. In addition, a second set, or second ones as shown in FIG. 2, can be used by an end-user to select, during the operation 206, the weather-related datapoints that are of interest to the user.

The skill weights can correspond to a confidence level that an end-user has in the ability of a source to provide an accurate weather forecast. If the end-user has a high confidence level, the end-user can provide a high skill weight. If the end-user has a low confidence level, the end-user can provide a low skill weight. The confidence level can be associated with historical data associated with weather forecasts provided by each of the sources. Thus, if a source provides weather forecasts that are historically accurate, the end-user can assign a high skill weight. If a source provides weather forecasts that are historically inaccurate, the end-user can assign a low skill weight. The skill weight can be any type of value, such as any value on a scale of zero to one, zero to ten, zero to hundred, zero to a thousand, or the like.

The accuracy rates can be determined based on a comparison between weather forecasts predicted by a source for a time T₁ and an actual forecast at the time T₁ where the forecast was predicted prior to the time T₁. Furthermore, different skill weights can be applied at different times to the same source depending on a weather event that is of interest to an end-user. For example, if an end-user is interested in knowing wind speeds at a particular time for a location, the end-user can assign skill weights based on an accuracy with which a source can predict wind speeds. Thus, if a first source historically accurately predicts wind speeds while a second source historically inaccurately predicts wind speeds, an end-user can assign a higher skill weight to the first source and a lower skill weight to the second source.

Furthermore, if an end-user is interested in knowing a weather threat level, such as if a hurricane is going to track to a certain location at a particular time, the end-user can assign skill weights based on an accuracy with which a source can predict tracks of hurricanes. Thus, if the first source historically inaccurately predicts tracks of hurricanes while the second source historically accurately predicts tracks of hurricanes, an end-user can further assign a lower skill weight to the first source and a higher skill weight to the second source. This variability with assigning skill weights to different sources can be based on any type of weather-related datapoint.

Returning to the illustration and FIG. 3, during the operation 206, the weather forecaster can be interested in ascertaining whether or not New Orleans will be in the path of a hurricane between September 3^{rd} and September 5^{th}. Furthermore, historically, the ECMWF™ has provided the most accurate tracks for hurricanes, followed by NOAA™ and the National Hurricane Center. In addition, the weather forecaster is interested in knowing the wind speed and precipitation amounts in New Orleans between September 3^{rd} and September 5^{th}. As such, the weather forecaster can provide a skill weight of 0.6 at the input 334 and a skill weight of 0.2 at the input 321. In addition, the weather forecaster can provide a skill weight of 0.1 at each of the inputs 332 and 336. These skill weights can correspond to the first set of inputs as discussed above.

Since the weather forecaster is interested in ascertaining whether or not New Orleans will be in the path of a hurricane between September 3^{rd} and September 5^{th}, the weather forecaster can provide an indicium 338 in the form of a checkmark at the input 330 to select the weather threat level weather-related datapoint 318. Moreover, the weather forecaster can provide an indicium 340 at the input 328 in the form of a checkmark to select the precipitation weather-related datapoint 316. The weather forecaster can also provide an indicium 342 in the form of a checkmark at the input 326 to select the wind speed weather-related datapoint 314. The indica 338-342 can correspond to the second set of inputs as discussed above.

Returning to FIG. 2 and the method 200, during an operation 208, the selected weather-related datapoints can be bias corrected. As described above, bias correcting can include adjusting a temperature if the source typically provides a weather forecast that runs hot such as a higher temperature than the actual temperature, or runs cold such as a lower temperature than the actual temperature. While the system is described as providing bias corrections, end-users can provide their own bias corrections instead of relying on the system to automatically provide bias-corrections.

Bias correcting can also include changing percentages that a weather forecast may assign to a possibility or a probability of a weather-related event occurring at a given location. To further illustrate, if a source typically provides a percentage likelihood associated with a weather threat level that is, on average, ten percent higher, during the operation 208, the percentage likelihood associated with a weather threat level will be decreased by 10%. In addition, if a source typically provides a percentage likelihood associated with a weather threat level that is, on average, 10% lower, during the operation 208, the percentage likelihood associated with a weather threat level will be increased by 10%. Bias correcting for weather-related events for a particular source can also vary for different types of weather-related events. Thus, if a source is typically 10% higher for hurricanes and is biased corrected by decreasing a percentage by 10% for hurricane predictions but is 10% lower for flooding, the same source can be bias corrected by increasing a percentage by 10% for flooding predictions.

Bias correcting can also be performed for other weather-related datapoints, such as humidity and precipitation levels along with wind speeds. Bias correcting can be performed in a manner similar to bias correction for a temperature, where if a first source predicts a humidity level of 55% at a first location at time T₁ and the actual humidity level is 45% at the time T₁, since the predicted humidity level is 55% and the actual humidity level is 45%, during the operation 208, a determination can be made that humidity level predictions from the first source are higher by an average of 10%. As such, humidity levels from the first source can be bias corrected by decreasing the forecasted humidity level by 10%. Moreover, if a second source predicts a humidity level of 35% at the first location at the time T₁ instead of 45%, since the predicted humidity level is 35% and the actual humidity level is 45%, the system can determine that humidity level predictions from the second source run lower by an average of 10%. In this instance, humidity levels from the first source can be bias corrected by increasing the forecasted humidity level by 10%. A similar process can be used to bias correct forecast windspeeds and any other type of weather-related datapoint.

Turning back to the illustration, the weather forecaster selected wind speed weather-related datapoint 314, the precipitation weather-related datapoint 316, and the weather threat level weather-related datapoint 318 during the operation 206. As such, during the operation 208, the server device 102 accesses an estimated forecast from each of the sources 302-306 that includes the weather-related datapoints 314-318.

In the illustration, the weather forecaster has selected a time period 344 between a time period 346 of September 1^{st} to September 7^{th}. While the illustration describes the time period 344 as being for seven days in one day increments, the time period 344 can be any length of time with any subdivisions. For example, the time period can be for a one-month length of time that is subdivided into hourly segments during the one-month length of time. The server device 102 accesses each of the server devices 112-118 respectively associated with the sources 302-304 to retrieve the wind speed weather-related datapoints 314, the precipitation weather-related datapoints 316, and the weather threat level weather-related datapoints 318. During the operation 208, the server device 102 bias corrects each of the weather-related datapoints 314-318.

Regarding weather-related datapoints, during the dates 346, the source 302 estimates weather-related datapoints:

TABLE I

| | | | |
|---|---|---|---|
| | | Precipitation | Weather |
| Date | Wind Speed | Amount | Threat Level |

| | | | | | |
|---|---|---|---|---|---|
| September 1^{st} | 4 | mph | >0.1 | inch | 10% |
| September 2^{nd} | 25 | mph | >0.1 | inch | 15% |
| September 3^{rd} | 80 | mph | 4 | inches | 80% |
| September 4^{th} | 80 | mph | 2 | inches | 80% |
| September 5^{th} | 50 | mph | >0.1 | inch | 15% |
| September 6^{th} | 10 | mph | >0.1 | inch | >1% |
| September 7^{th} | 4 | mph | >0.1 | inch | >1% |

Furthermore, the machine learning model 120 determines that the source 302 typically overestimates wind speeds by 5 miles per hour (mph), underestimates precipitation by 15%, and accurately predicts hurricane tracks 70% of the time using historical estimated weather forecasts and actual weather forecasts as discussed above. Accordingly, the machine learning model 120 bias corrects the estimated weather-related datapoints as shown below according to the overestimates and underestimates and the percentage accuracy. For example, the machine learning model 120 reduces the wind speeds by 5 mph, increases the precipitation amounts by 15%, and reduces the weather threat levels by 25%. Therefore, the machine learning model 120 bias corrects the weather-related datapoints as follows during the operation 208:

TABLE II

| | | | |
|---|---|---|---|
| | | Precipitation | Weather |
| Date | Wind Speed | Amount | Threat Level |

| | | | | | |
|---|---|---|---|---|---|
| September 1^{st} | >1 | mph | >0.1 | inch | 7.5% |
| September 2^{nd} | 20 | mph | >0.1 | inch | 11.25% |
| September 3^{rd} | 75 | mph | 4.6 | inches | 60% |
| September 4^{th} | 75 | mph | 2.3 | inches | 60% |
| September 5^{th} | 45 | mph | >0.1 | inch | 11.25% |
| September 6^{th} | 5 | mph | >0.1 | inch | >1% |
| September 7^{th} | >1 | mph | >0.1 | inch | >1% |

Regarding weather-related datapoints, during the dates 346, the source 304 estimates weather-related datapoints:

TABLE III

| | | | |
|---|---|---|---|
| | | Precipitation | Weather |
| Date | Wind Speed | Amount | Threat Level |

| | | | | | |
|---|---|---|---|---|---|
| September 1^{st} | >1 | mph | >0.1 | inch | 10% |
| September 2^{nd} | 10 | mph | >0.1 | inch | 10% |
| September 3^{rd} | 25 | mph | 1 | inch | 20% |
| September 4^{th} | 25 | mph | 0.5 | inches | 20% |
| September 5^{th} | 10 | mph | >0.1 | inch | 10% |
| September 6^{th} | 10 | mph | >0.1 | inch | >1% |
| September 7^{th} | >1 | mph | >0.1 | inch | >1% |

Furthermore, the machine learning model 120 determines that the source 304 typically overestimates wind speeds by 3 mph, overestimates precipitation by 10%, and accurately predicts hurricane tracks 50% of the time using historical estimated weather forecasts and actual weather forecasts as discussed above. Accordingly, the machine learning model 120 bias corrects the estimated weather-related datapoints as shown below according to the overestimates and the percentage accuracy. For example, the machine learning model 120 reduces the wind speeds by 3 mph, decreases the precipitation amounts by 10%, and reduces the weather threat levels by 50%. Therefore, the machine learning model 120 bias corrects the weather-related datapoints as follows during the operation 208:

TABLE IV

| | | | |
|---|---|---|---|
| | | Precipitation | Weather |
| Date | Wind Speed | Amount | Threat Level |

| | | | | | |
|---|---|---|---|---|---|
| September 1^{st} | >1 | mph | >0.1 | inch | 5% |
| September 2^{nd} | 7 | mph | >0.1 | inch | 5% |
| September 3^{rd} | 22 | mph | 0.9 | inches | 10% |
| September 4^{th} | 22 | mph | .45 | inches | 10% |
| September 5^{th} | 7 | mph | >0.1 | inch | 5% |
| September 6^{th} | 7 | mph | >0.1 | inch | >1% |
| September 7^{th} | >1 | mph | >0.1 | inch | >1% |

Regarding weather-related datapoints, during the dates 346, the source 306 estimates weather-related datapoints:

TABLE V

| | | | |
|---|---|---|---|
| | | Precipitation | Weather |
| Date | Wind Speed | Amount | Threat Level |

| | | | | | |
|---|---|---|---|---|---|
| September 1^{st} | >1 | mph | >0.1 | inch | 10% |
| September 2^{nd} | 10 | mph | >0.1 | inch | 10% |
| September 3^{rd} | 95 | mph | 4 | inches | 90% |
| September 4^{th} | 95 | mph | 2.5 | inches | 90% |
| September 5^{th} | 30 | mph | 1 | inch | 50% |
| September 6^{th} | 10 | mph | >0.1 | inch | >1% |
| September 7^{th} | >1 | mph | >0.1 | inch | >1% |

Additionally, the machine learning model 120 determines that the source 306 typically underestimates wind speeds by 5 mph, overestimates precipitation by 10%, and accurately predicts hurricane tracks 90% of the time using historical estimated weather forecasts and actual weather forecasts as discussed above. Accordingly, the machine learning model 120 bias corrects the estimated weather-related datapoints as shown below according to the overestimates, the underestimates, and the percentage accuracy. For example, the machine learning model 120 increases the wind speeds by 5 mph, decreases the precipitation amounts by 10%, and reduces the weather threat levels by 10%. Therefore, the machine learning model 120 bias corrects the weather-related datapoints as follows during the operation 208:

TABLE VI

| | | | |
|---|---|---|---|
| | | Precipitation | Weather |
| Date | Wind Speed | Amount | Threat Level |

| | | | | | |
|---|---|---|---|---|---|
| September 1^{st} | 5 | mph | >0.1 | inch | 9% |
| September 2^{nd} | 15 | mph | >0.1 | inch | 9% |
| September 3^{rd} | 100 | mph | 3.6 | inches | 81% |
| September 4^{th} | 100 | mph | 2.25 | inches | 81% |
| September 5^{th} | 35 | mph | >0.1 | inch | 45% |
| September 6^{th} | 15 | mph | >0.1 | inch | >1% |
| September 7^{th} | >1 | mph | >0.1 | inch | >1% |

Regarding weather-related datapoints, during the dates 346, the source 308 estimates weather-related datapoints:

TABLE VII

| | | | |
|---|---|---|---|
| | | Precipitation | Weather |
| Date | Wind Speed | Amount | Threat Level |

| | | | | | |
|---|---|---|---|---|---|
| September 1^{st} | >1 | mph | >0.1 | inch | 10% |
| September 2^{nd} | 10 | mph | >0.1 | inch | 10% |
| September 3^{rd} | 25 | mph | 1 | inch | 20% |
| September 4^{th} | 25 | mph | 0.5 | inches | 20% |
| September 5^{th} | 10 | mph | >0.1 | inch | 10% |
| September 6^{th} | 10 | mph | >0.1 | inch | >1% |
| September 7^{th} | >1 | mph | >0.1 | inch | >1% |

Furthermore, the machine learning model 120 determines that the source 308 typically overestimates wind speeds by 5 mph, overestimates precipitation by 10%, and accurately predicts hurricane tracks 60% of the time using historical estimated weather forecasts and actual weather forecasts as discussed above. Accordingly, the machine learning model 120 bias corrects the estimated weather-related datapoints as shown below according to the overestimates and the percentage accuracy. For example, the machine learning model 120 reduces the wind speeds by 5 mph, decreases the precipitation amounts by 10%, and reduces the weather threat levels by 60%. Therefore, the machine learning model 120 bias corrects the weather-related datapoints as follows during the operation 208:

TABLE VIII

| | | | |
|---|---|---|---|
| | | Precipitation | Weather |
| Date | Wind Speed | Amount | Threat Level |

| | | | | | |
|---|---|---|---|---|---|
| September 1^{st} | >1 | mph | >0.1 | inch | 6% |
| September 2^{nd} | 5 | mph | >0.1 | inch | 6% |
| September 3^{rd} | 20 | mph | 0.9 | inches | 12% |
| September 4^{th} | 20 | mph | .45 | inches | 12% |
| September 5^{th} | 5 | mph | >0.1 | inch | 6% |
| September 6^{th} | 5 | mph | >0.1 | inch | >1% |
| September 7^{th} | >1 | mph | >0.1 | inch | >1% |

Returning to FIG. 2 and the method 200, after the weather-related datapoints are bias corrected during the operation 208, the method 200 performs an operation 210 where the trained machine learning model 120 (hereinafter “machine learning model 120”) generates an estimated weather forecast for a location using the bias corrected weather-related datapoints based on the skill weights associated with each source of the plurality of sources. The machine learning model can be trained as will be discussed further below. The bias corrected weather-related datapoints can be skill weighted using the skill weights provided during the operation 206 using any suitable technique. In an example, the bias corrected weather-related datapoints can be skill weighted with the skill weights using the following:

$$( W R {D}_{1} ) ( {W}_{1} ) + ( W R {D}_{2} ) ( {W}_{2} ) … + ( {WRD}_{N} ) ( {W}_{N} ) = Final Forecast \qquad ( 1 )$$

WRD can relate to a bias corrected weather-related datapoint and W can relate to the skill weight for the source from which the weather-related datapoint originated.

Alternatively, instead of using the weighting formula described above, the machine learning model can select the biased corrected weather-related datapoints from the source having the highest assigned skill weight. Thus, if the source 306 has the highest assigned skill weight, then the machine learning model can select all the biased corrected weather-related datapoints from the source 306.

Moreover, it should be noted that an end-user can select the weighted combination. An end-user can also select the model that highest skill weight, change the weights before combining, or a combination

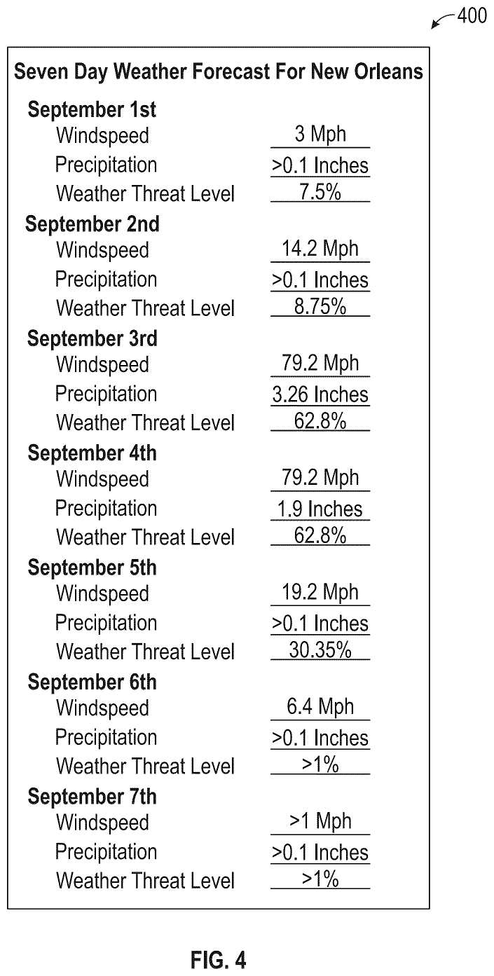

Returning to the illustration, during the operation 210, the machine learning model 120 can generate an estimated forecast 400 (FIG. 4) using equation (1) shown above in conjunction with the values in Tables II, IV, VI, and VIII also shown above within the time period 344. Here, the machine learning model 120 skill weights the values in the Tables IV and VII by 0.1 since this was the skill weight assigned to the sources 304 and 308 during the operation 206. Moreover, the machine learning model 120 skill weights the values in the Table II by 0.2 and the values in Table VI by 0.6 in accordance with the skill weights provided during the operation 206 for the sources 302 and 306, respectively. In the illustration, the weather forecaster can further bias correct any of the weather-related datapoint values in the estimated forecast after the estimated weather forecast is provided to the weather forecaster.

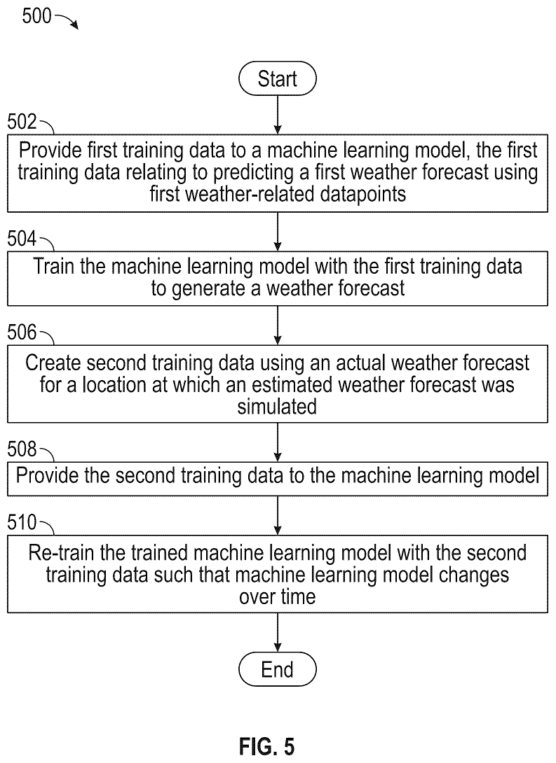

As noted above, the server device 102 includes the machine learning model 120. Now making reference to FIG. 5, a method 500 for training the machine learning model 120 is shown. During an operation 502, the method 500 can provide first training data to the machine learning model 120. The first training data can relate to predicting a first weather forecast using first weather-related datapoints, such as the weather-related datapoints described above. The first training data can also include weather forecasts that were generated using the first training data. The first training data can include bias corrections as described above. The first training data can also include skill weights that can be applied to weather forecasts from different sources based on the accuracy of the estimated weather forecasts when the estimated weather forecasts are compared to the actual weather forecasts as described above.

During an operation 504, the machine learning model 120 is trained with the first training data to generate an estimated weather forecast. In particular, the machine learning model 120 can be trained how to generate the first weather forecast using the first training data. The machine learning model 120 can be any of the models described above and can employ the features, components, and processes described above in order to generate a weather forecast using the first weather-related datapoints during the method 500.

After training with the first training data, during an operation 506, second training data can be created using an actual weather forecast for a location at which an estimated weather forecast was generated, such as the weather forecast estimated with the method 200. In particular, the actual weather forecast during the dates 346 for the location associated with the actual weather forecast can be used to create the second training data during the operation 506. The second training data can also relate to changing an amount of bias correcting that can occur based on a difference between estimated weather forecasts and actual weather forecasts. For example, at time T_{1M}, the first training data bias can bias correct temperatures by increasing temperatures by 3°. However, during a six-month period between the time T_{1M} and a time T_{6M}, if a difference between estimated weather forecasts and actual weather forecasts indicates that the temperature should be bias corrected by increasing the estimated temperature by 5°, the second training data can bias correct temperatures by increasing temperatures by 5°.

The second training data can also include updated skill weights that can be applied to sources of estimated weather forecasts. For example, if the first training data indicates that a source should have a higher weighting based on an 80% accuracy rate at the time T_{1M}, if a determination is made based on comparing estimated weather forecasts with actual weather forecasts between the time T_{6M} and the time T_{6M} that the source has a 40% accuracy at the time T_{1M}, the weight associated with the source can be lowered in the second training data.

The second training data can then be provided to the machine learning model 120 during an operation 508 to retrain the machine learning model 120 with the second training data during an operation 510. Thus, the machine learning model 120 can change over time and can be refined over time based on changing conditions associated with the weather-related datapoints, such as global warming and other factors that can affect how the weather-related datapoints can relate to weather forecasts.

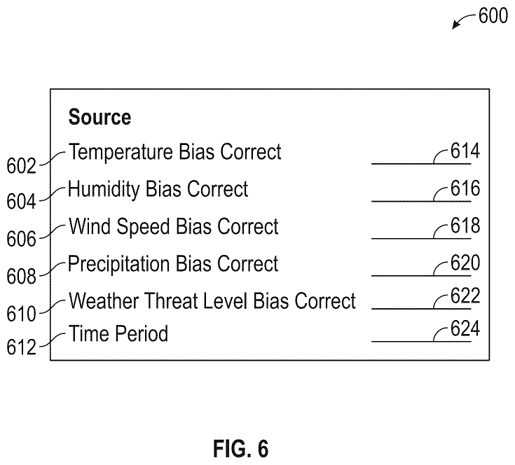

In examples, an end-user, such as a weather forecaster, can bias correct weather-related datapoints at a user interface in addition to, or instead of, the server device 102 bias correcting weather-related datapoints. To further illustrate, an end-user can be presented with a user interface 600 that includes weather-related datapoints 602-612 that can be bias corrected at the user interface 600. More specifically, each of the weather-related datapoints 602-612 can include respective inputs 614-624 that can allow an end-user to bias correct any of the weather-related datapoints 602-612. Any of the weather-related datapoints mentioned herein can be bias corrected as described with reference to FIG. 6.

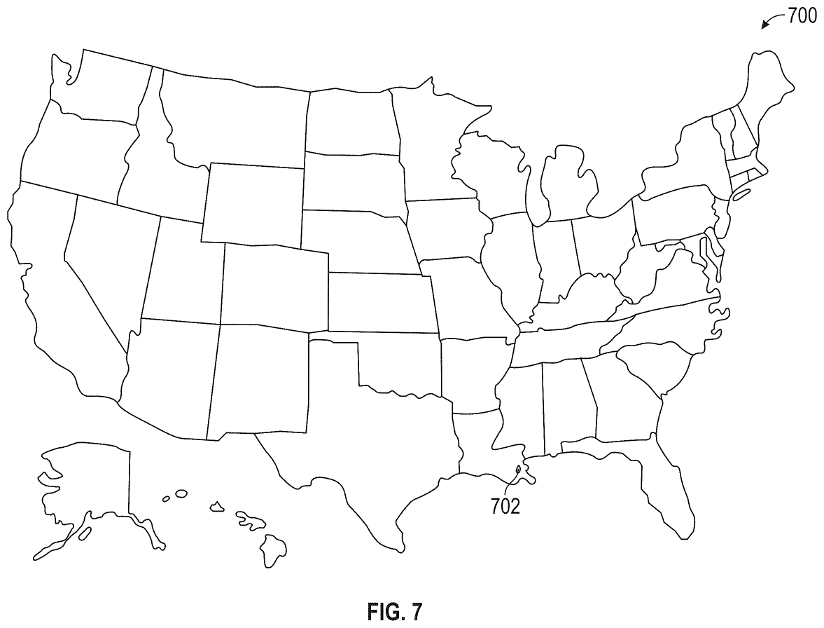

In addition, an end-user may be provided with an interactive map 700 that is configured to receive input from an end-user as shown with reference to FIG. 7. Thus, if an end-user would like an estimated weather forecast for a location, the end-user can select the location on the interactive map 700, such as the location 702. When the end-user selects a location, the method 200 can be performed as described above. Here, the location 702 can correspond to New Orleans. Thus, in the illustration, if the interactive map 700 is presented to the weather forecaster, the weather forecaster can select the location 702 and the method 200 along with the illustration as described above can proceed.

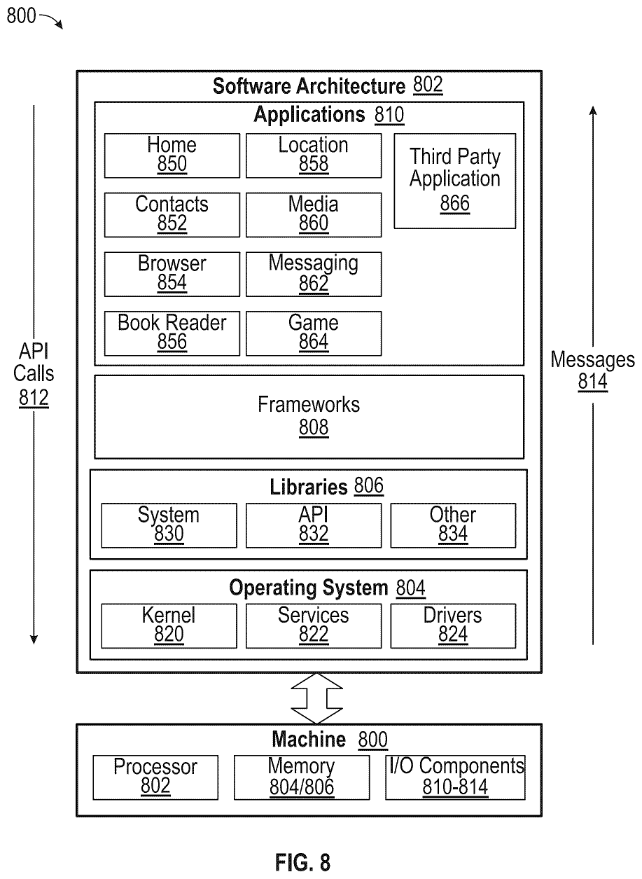

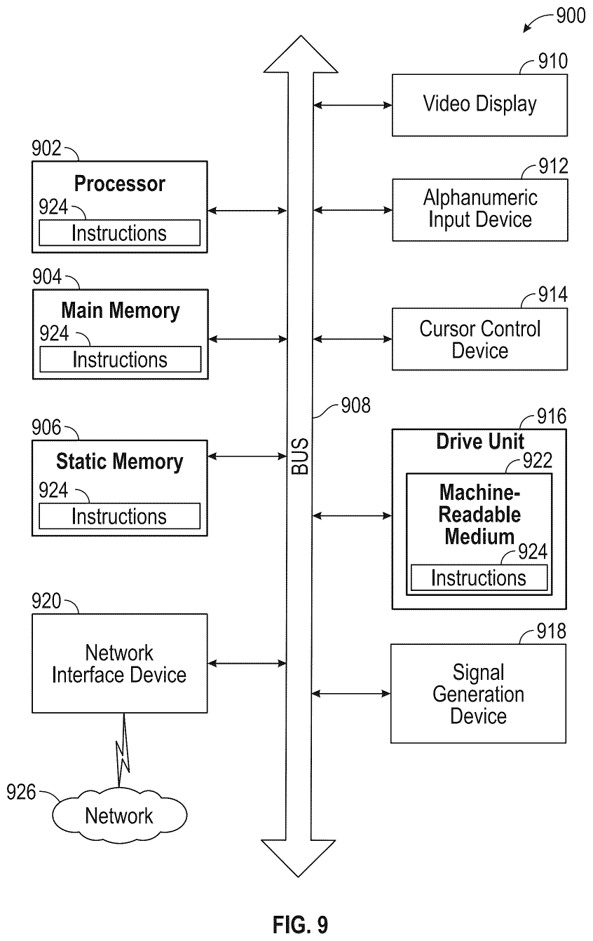

FIG. 8 is a block diagram 800 illustrating a software architecture 802, which may be installed on any one or more of the devices described above. FIG. 9 is merely a non-limiting example of a software architecture, and it will be appreciated that many other architectures may be implemented to facilitate the functionality described herein. The software architecture 802 may be implemented by hardware such as a computer system 900 of FIG. 9 that includes a processor 902, memory 904 and 906, and I/O components 910-914. In this example, the software architecture 802 may be conceptualized as a stack of layers where each layer may provide a particular functionality. For example, the software architecture 802 includes layers such as an operating system 804, libraries 806, frameworks 808, and applications 810. Operationally, the applications 810 invoke application programming interface (API) calls 812 through the software stack and receive messages 814 in response to the API calls 812, according to some implementations.

In various implementations, the operating system 804 manages hardware resources and provides common services. The operating system 804 includes, for example, a kernel 820, services 822, and drivers 824. The kernel 820 acts as an abstraction layer between the hardware and the other software layers in some implementations. For example, the kernel 820 provides memory management, processor management (e.g., scheduling), component management, networking, and security settings, among other functionality. The services 822 may provide other common services for the other software layers. The drivers 824 may be responsible for controlling or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 806 provide a low-level common infrastructure that may be utilized by the applications 810. The libraries 806 may include system libraries 830 (e.g., C standard library) that may provide functions such as memory allocation functions, string manipulation functions, mathematic functions, and the like. In addition, the libraries 806 may include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 may also include a wide variety of other libraries 834 to provide many other APIs to the applications 810.

The frameworks 808 provide a high-level common infrastructure that may be utilized by the applications 810, according to some implementations. For example, the frameworks 808 provide various graphic user interface (GUI) functions, high-level resource management, high-level location services, and so forth. The frameworks 808 may provide a broad spectrum of other APIs that may be utilized by the applications 810, some of which may be specific to a particular operating system or platform.

In an example, the applications 810 include a home application 850, a contacts application 852, a browser application 854, a book reader application 856, a location application 858, a media application 860, a messaging application 862, a game application 864, and a broad assortment of other applications such as a third-party application 866. According to some examples, the applications 810 are programs that execute functions defined in the programs. Various programming languages may be employed to create one or more of the applications 810, structured in a variety of manners, such as object-orientated programming languages (e.g., Objective-C, Java, or C++) or procedural programming languages (e.g., C or assembly language). In a specific example, the third-party application 866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 866 may invoke the API calls 812 provided by the mobile operating system (e.g., the operating system 804) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 110 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 9 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device (cursor control device) 914 (e.g., a mouse), a disk drive unit 916, a signal generation device 918 (e.g., a speaker) and a network interface device 920.

The drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. Instructions 924 may also reside within the static memory 906.

While the machine-readable medium 922 is shown in an example to be a single medium, the term “machine-readable medium” may include a single medium or multiple media (e.g., a centralized or distributed database, and/or associated caches and servers) that store the one or more instructions or data instructions 924. The term “machine-readable medium” shall also be taken to include any tangible medium that is capable of storing, encoding or carrying instructions 924 for execution by the machine and that cause the machine to perform any one or more of the methodologies of the present invention, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 924 may further be transmitted or received over the network 110 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 924 for execution by the machine, and includes digital or analog communications signals or other intangible media to facilitate communication of such software.

In various example examples, one or more portions of the network 110 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 110 or a portion of the network 110 may include a wireless or cellular network, and a coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” “device-readable medium,” and “machine storage medium,” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense. It will be understood that changes and modifications may be made to the disclosed embodiments without departing from the scope of the present disclosure. These and other changes or modifications are intended to be included within the scope of the present disclosure.

What is claimed is:

1. A system comprising:
processing circuitry; and
a memory device including instructions stored thereon, wherein the instructions, which when executed by the processing circuitry, configure the processing circuitry to perform operations that:
provide first training data to a machine learning model, the first training data relating to predicting a first weather forecast using first weather-related datapoints;
train the machine learning model with the first training data;
receive a set of second weather-related datapoints from a plurality of sources;
cause a first user interface to be displayed, the first user interface including:
a list of the set of second weather-related datapoints that lists the plurality of sources associated with each of the second weather-related datapoints; and
a plurality of inputs at each datapoint of the set of second weather-related datapoints;
receive user inputs at ones of the plurality of inputs, wherein:
first ones of the user inputs correspond to weights relating to each source of the plurality of sources associated with each of the second weather-related datapoints; and
second ones of the user inputs correspond to selected weather-related datapoints of the second weather-related datapoints;
bias correct a subset of the set of second weather-related datapoints;
generate, using the trained machine learning model, an estimated weather forecast for a location using the bias corrected subset second weather-related datapoints based on the weights associated with each source of the plurality of sources;
determine an actual weather forecast at the location after the estimated weather is determined;
create second training data using the actual weather forecast;
provide the second training data to the machine learning model; and
re-train the trained machine learning model with the second training data such that machine learning model changes over time.

2. The system of claim 1, wherein when performing the bias correct, the instructions further configure the processing circuitry to perform operations that:
estimate a first weather-related datapoint at a location at a first time period;
retrieve an actual weather-related datapoint for the location at the first time period during a second time period that is after the first time period;
determine a difference between the actual weather-related datapoint and the estimated first weather-related datapoint; and
perform the bias correct by adjusting an estimated second weather-related datapoint at the location at a third time using the difference.

3. The system of claim 2, where the bias correct includes increasing a value associated a weather-related datapoint of the set of weather-related datapoints.

4. The system of claim 2, where the bias correct includes decreasing a value associated a weather-related datapoint of the set of weather-related datapoints.

5. The system of claim 1, wherein the user input corresponds to a value for the bias correct and when bias correcting the subset of the set of second weather-related datapoints and the instructions further configure the processing circuitry to bias correct the subset of the set of second weather-related datapoints using the bias correct value.

6. The system of claim 5, wherein the bias correct value increases a value associated a weather-related datapoint of the set of weather-related datapoints.

7. The system of claim 5, wherein the bias correct value decreases a value associated a weather-related datapoint of the set of weather-related datapoints.

8. A non-transitory, machine-readable medium, comprising instructions, which when performed by a processor of a machine, causes the processor to perform operations to:
provide first training data to a machine learning model, the first training data relating to predicting a first weather forecast using first weather-related datapoints;
train the machine learning model with the first training data;
receive a set of second weather-related datapoints from a plurality of sources;
cause a first user interface to be displayed, the first user interface including:
a list of the set of second weather-related datapoints that lists the plurality of sources associated with each of the second weather-related datapoints; and
a plurality of inputs at each datapoint of the set of second weather-related datapoints;
receive user inputs at ones of the plurality of inputs, wherein:
first ones of the user inputs correspond to weights relating to each source of the plurality of sources associated with each of the second weather-related datapoints; and
second ones of the user inputs correspond to selected weather-related datapoints of the second weather-related datapoints;
bias correct a subset of the set of second weather-related datapoints;
generate, using the trained machine learning model, an estimated weather forecast for a location using the bias corrected subset second weather-related datapoints based on the weights associated with each source of the plurality of sources;
determine an actual weather forecast at the location after the estimated weather is determined;
create second training data using the actual weather forecast;
provide the second training data to the machine learning model; and
re-train the trained machine learning model with the second training data such that machine learning model changes over time.

9. The non-transitory, machine-readable medium of claim 8, wherein when performing the bias correct, the processor is further configured to perform operations that:
estimate a first weather-related datapoint at a location at a first time period;
retrieve an actual weather-related datapoint for the location at the first time period during a second time period that is after the first time period;
determine a difference between the actual weather-related datapoint and the estimated first weather-related datapoint; and
perform the bias correct by adjusting an estimated second weather-related datapoint at the location at a third time using the difference.

10. The non-transitory, machine-readable medium of claim 9, where the bias correct includes increasing a value associated a weather-related datapoint of the set of weather-related datapoints.

11. The non-transitory, machine-readable medium of claim 9, where the bias correct includes decreasing a value associated a weather-related datapoint of the set of weather-related datapoints.

12. The non-transitory, machine-readable medium of claim 8, wherein the user input corresponds to a value for the bias correct and when bias correcting the subset of the set of second weather-related datapoints and the processor is further configured to bias correct the subset of the set of second weather-related datapoints using the bias correct value.

13. The non-transitory, machine-readable medium of claim 8, wherein the bias correct value increases a value associated a weather-related datapoint of the set of weather-related datapoints.

14. The non-transitory, machine-readable medium of claim 8, wherein the bias correct value decreases a value associated a weather-related datapoint of the set of weather-related datapoints.

15. A method comprising:
providing first training data to a machine learning model, the first training data relating to predicting a first weather forecast using first weather-related datapoints;
training the machine learning model with the first training data;
receiving a set of second weather-related datapoints from a plurality of sources;
causing a first user interface to be displayed, the first user interface including:
a list of the set of second weather-related datapoints that lists the plurality of sources associated with each of the second weather-related datapoints; and
a plurality of inputs at each datapoint of the set of second weather-related datapoints;
receiving user inputs at ones of the plurality of inputs, wherein:
first ones of the user inputs correspond to weights relating to each source of the plurality of sources associated with each of the second weather-related datapoints; and
second ones of the user inputs correspond to selected weather-related datapoints of the second weather-related datapoints;
bias correcting a subset of the set of second weather-related datapoints;
generating, using the trained machine learning model, an estimated weather forecast for a location using the bias corrected subset second weather-related datapoints based on the weights associated with each source of the plurality of sources;
determining an actual weather forecast at the location after the estimated weather is determined;
creating second training data using the actual weather forecast;
providing the second training data to the machine learning model; and
re-training the trained machine learning model with the second training data such that machine learning model changes over time.

16. The method of claim 15, wherein when performing the bias correct, the method further comprises:
estimating a first weather-related datapoint at a location at a first time period;
retrieving an actual weather-related datapoint for the location at the first time period during a second time period that is after the first time period;
determining a difference between the actual weather-related datapoint and the estimated first weather-related datapoint; and
performing the bias correct by adjusting an estimated second weather-related datapoint at the location at a third time using the difference.

17. The method of claim 16, where the bias correcting includes increasing a value associated a weather-related datapoint of the set of weather-related datapoints.

18. The method of claim 16, where the bias correcting includes decreasing a value associated a weather-related datapoint of the set of weather-related datapoints.

19. The method of claim 15, wherein the user input corresponds to a value for the bias correct and when bias correcting the subset of the set of second weather-related datapoints and the method further comprises bias correcting the subset of the set of second weather-related datapoints using the bias correct value and the bias correct value increases a value associated a weather-related datapoint of the set of weather-related datapoints.

20. The method of claim 15, wherein the user input corresponds to a value for the bias correct and when bias correcting the subset of the set of second weather-related datapoints and the method further comprises bias correcting the subset of the set of second weather-related datapoints using the bias correct value and the bias correct value decreases a value associated a weather-related datapoint of the set of weather-related datapoints.
